(19) United States
(12) Patent Application Publication
(10) Pub. No.: US 2017/0339667 A1
(43) Pub. Date: Nov. 23, 2017

(54) METHOD FOR RECEIVING/SENDING PAGING MESSAGE AND RELATED NETWORK AND USER EQUIPMENT

(71) Applicant: Sharp Kabushiki Kaisha, Sakai City, Osaka (JP)

(72) Inventors: XINGYA SHEN, Shanghai (CN); FANGYING XIAO, Shanghai (CN); RENMAO LIU, Shanghai (CN)

(73) Assignee: Sharp Kabushiki Kaisha, Sakai City ,Osaka (JP)

(21) Appl. No.: 15/533,461

(22) PCT Filed: Dec. 28, 2015
(86) PCT No.: PCT/CN2015/099191

§ 371 Date: Jun. 6, 2017

(30) Foreign Application Priority Data
Dec. 30, 2014 (CN) 201410843366.5

(51) Int. Cl. H04W 68/02; H04W 76/04; H04W 72/04; H04W 88/08; H04W 4/00; H04W 88/02

(52) U.S. Cl. CPC H04W 68/02; H04W 76/046; H04W 72/0406; H04W 4/005; H04W 88/02; H04W 88/08

(57) ABSTRACT

The present invention provides a method for receiving/sending a paging message and corresponding network node/user equipment. The method comprises: receiving an indication for a physical resource block group for transmitting the paging message, determining an index of the physical resource block group in a subframe according to the level of the paging message; and receiving the paging message over the indicated physical resource block group. According to the technical solution, a paging message transmission mechanism applicable to enhanced coverage MTC user equipment and/or low-complexity or low-cost MTC user equipment can be provided.

### TECHNICAL FIELD

The present invention relates to the technical field of wireless communication. More specifically, the present invention relates to a method for receiving/sending a paging message and a related network node/user equipment.

### BACKGROUND ART

The long-term evolution (LTE) project, deployed by the Third Generation Mobile Communications Partnership Program (3GPP) organization, is designed to provide a future mobile communications service with increasing diversity. Wireless cellular communications have increasingly becoming an integral part of public life and work. Orthogonal frequency division multiple access (OFDMA) and multi-antenna (MIMO) techniques are introduced in the first release (i.e., Release 8) of 3GPP LTE. 3GPP Release 10, upon the evaluation and testing of International Telecommunications Union, has officially become the fourth generation global mobile communication standard LTE-Advanced. In the LTE-Advanced standard, the carrier aggregation (CA) and relay technology are introduced to enhance the uplink/downlink MIMO technology and also support heterogeneous network (HetNet) deployment.

In order to meet the future market demand for home equipment communications and large-scale Internet of Things (IOT) deployments, 3GPP has decided to introduce low-cost Machine Type Communication (MTC) in LTE and its upgraded releases, migrating the MTC service from the current GSM network support to LTE network support and defining a number of new types of user equipment (UE). One of the new types of user equipment is called low-cost MTC user equipment (Low-cost MTC UE). This type of MTC UE supports MTC service in all duplex modes of existing LTE networks and has the following performances: 1) single receiving antenna; 2) the maximum downlink and uplink transport block size (TBS) is 1000 bits; 3a) the baseband bandwidth of the downlink data channel is reduced to 1.4 MHz, the bandwidth of the downlink control channel is consistent with that the network side system, the uplink channel bandwidth and the downlink radio frequency part are consistent with those of the user equipment in the existing LTE network; 3b) the baseband bandwidth of the downlink/uplink control channel and the data channel is reduced to 1.4 MHz.

MTC is a data communication service that does not require human participation. Large-scale MTC user equipment deployment can be used in fields such as security, tracking, payment, measurement, and consumer electronics, and specifically relates to applications including video surveillance, supply chain tracking, smart electric meters, and remote monitoring. MTC user equipment requires lower power consumption and supports lower data rate and lower mobility.

At present, the LTE system is mainly for human-to-human (H2H) communication services. Therefore, the key to achieve the scale competitive advantage and application prospect of MTC service is that LTE network supports low-cost MTC user equipment to work with low cost and low complexity.

Some MTC user equipment needs to be installed in the basement of a residential building or at a position under the protection of an insulating foil, a metal window or the thick wall of a traditional building; as compared with conventional equipment terminals (such as mobile phones, tablet computers, etc.) in LTE networks, the air interfaces of such equipment will obviously suffer from more serious penetration losses. 3GPP has decided to study the LTE network to provide MTC user equipment with a solution design of additional 20 dB/15 dB coverage enhancement service and performance evaluation. It is worth noting that MTC user equipment located in poor network coverage areas has the characteristics of very low data rate, very relaxed latency requirement, and limited mobility. For this feature of the MTC user equipment, the LTE network can further optimize some signaling and/or channels to support MTC user equipment. The 3GPP requires the provision of a certain LTE network coverage enhancement for newly defined MTC user equipment and other user equipment using MTC service (e.g., very relaxed delay requirements); for example, the LTE frequency division duplex (FDD) network is provided with 15 dB Network coverage enhancement. In addition, not all user equipment that uses MTC service requires the same network coverage enhancement.

At a 3GPPRAN #64 meeting held in June 2014, a new work item on Rel-13-oriented even lower complexity and enhanced coverage MTC was proposed (see Non-Patent Document: RP-140990 New Work Item on Even Lower Complexity and Enhanced Coverage LTE UE for MTC, Ericsson, NSN). In the description of this work item, the LTE Rel-13 system needs to support MTC user equipment having uplink/downlink 1.4 MHz RF bandwidth (hereinafter referred to as narrowband MTC UE) to operate at any system bandwidth (e.g., 1.4 MHz, 3 MHz, 5 MHz, 10 MHz, 15 MHz, 20 MHz, etc.) and provides coverage enhancements for such MTC users. In the system design, low-cost MTC users and enhanced coverage MTC users adopt a unified design. Reducing the energy consumption of MTC user equipment is one of the main objectives of this work item.

In the case that 3GPP LTE user equipment operates MTC service and is under the coverage enhancement mode, the coverage enhancement design and configuration of the physical layer channels such as (E) PDCCH/PDSCH/PUCCH/PUSCH is a work with required standardization. According to the discussion at the 3GPPRAN1 #74 meeting, after the initial access is completed, for any physical channel requiring retransmission, its configuration mode depends on the base station side. However, a delay of 2 to 10 seconds will be introduced when the MTC user equipment combines and demodulates a large amount of repeating data. This delay increases the power consumption of the MTC user equipment. According to the decision made at the 3GPP RANI #74b meeting, for the MTC user equipment requiring coverage enhancement, the transmission of the data channel shall be performed after the control channel transmission is completed. Therefore, in order to reduce the power consumption of the user equipment, a physical downlink control channel may not be required for paging message transmission of MTC user equipment requiring coverage enhancement. Moreover, since the low complexity MTC UE has a similar information transmission mechanism with enhanced coverage MTC user equipment, it is necessary to design a paging message transmission mechanism applicable to enhanced coverage MTC user equipment and/or low complexity or low cost MTC user equipment. Therefore, in Rel-12 and its upgraded releases, the paging message transmission for enhanced coverage MTC user equipment and/or low complexity or low cost MTC user equipment needs to be re-standardized

### SUMMARY OF THE INVENTION

The present invention is directed to providing a paging message transmission mechanism applicable to, for example, enhanced coverage MTC user equipment and/or a low complexity or low cost MTC user equipment.

According to one aspect of the present invention, a method for receiving a paging message by user equipment is provided. The method comprises: receiving an indication for a physical resource block group used for transmitting the paging message, wherein an index of the physical resource block group in a subframe is determined according to a level of the paging message; and receiving the paging message from the indicated physical resource block group.

According to another aspect of the present invention, a method for sending a paging message by a network node is provided. The method comprises: determining, according to the level of the paging message, an index of a physical resource block group used for transmitting the paging message in a subframe; informing a user equipment, serving as a receiver of the paging message, of an indication for the physical resource block group, and sending the paging message from the determined physical resource block group.

According to yet another aspect of the present invention, user equipment is provided. The user equipment includes a receiving unit, configured to receive an indication for a physical resource block group used for transmitting a paging message and to receive the paging message from the indicated physical resource block group, wherein an index of the physical resource block group in a subframe is determined according to a level of the paging message.

According to another aspect of the present invention, a network node is provided. The base station comprises: a block group index determining unit, configured to, according to a level of the paging message, determine an index of a physical resource block group used for transmitting the paging message in a subframe; and a sending unit, configured to inform a user equipment, serving as a receiver of the paging message, of an indication for the physical resource block group determined by the block group index determining unit, and send the paging message from the determined physical resource block group.

The aforementioned aspects of the present invention are simple and easy to implement. In addition, parameters (e.g., indexes) of physical resource blocks used for transmitting a paging message depend on the level of the paging message; and the level of the paging message is likewise applicable to coverage enhancement for MTC user equipment. Therefore, the solutions are applicable to paging message transmission for both enhanced coverage MTC user equipment and/or low complexity or low cost MTC user equipment.

### BRIEF DESCRIPTION OF THE DRAWINGS

Above and other features of the present invention will be more obvious from the detailed description below with reference to the accompanying drawings, in which

FIG. 1 is a flow chart of a method for receiving a paging message according to the present invention;

FIG. 2 is a flow chart of a method for sending a paging message according to the present invention;

FIG. 3 is a schematic block diagram of user equipment for receiving a paging message according to the present invention;

FIG. 4 is a schematic block diagram of a base station for sending a paging message according to the present invention;

FIG. 5 is a schematic diagram of resource block groups taken by paging messages having the same size at different levels;

FIG. 6 is a schematic diagram of a correspondence between paging messages at different levels and the starting indexes of corresponding resource blocks;

FIG. 7 is a schematic diagram of resource block groups taken by paging messages having different size at different levels;

FIG. 8 is a schematic diagram of a correspondence between paging messages at different levels and the sizes of occupied resource block groups;

FIG. 9 is another schematic diagram of a correspondence between different paging levels and the start indexes of corresponding resource blocks; and

FIG. 10 is another schematic diagram of dividing a system band into multiple sub-bands.

### DETAILED DESCRIPTION OF THE PREFERRED EMBODIMENTS

In the following description, a method for sending/receiving paging messages of MTC user equipment requiring additional coverage enhancement or low complexity/low cost MTC user equipment from frequency domain resources, a network node, and user equipment will be set forth as preferred embodiments in conjunction with accompanying drawings. It should be noted that although the present invention is described with respect to MTC user equipment requiring additional coverage enhancement or low complexity/low cost MTC user equipment, the present invention is likewise applicable to user equipment supporting delay tolerance service and/or requiring a certain coverage enhancement. It should also be noted that the present invention shall not be limited to the preferred embodiments described below. In addition, for the purpose of brevity, specific details of the conventional technology which are not directly related to the present invention may be omitted so as not to obscure the present invention.

In the following description, an LTE mobile communication system and its subsequent evolved releases are used as exemplary application environments from which details of the embodiments of the present invention are given. It is to be noted, however, that the present invention is not limited to the following embodiments and is applicable to more wireless communication systems, such as a future 5G cellular communication system or another existing communication system, as long as the systems require provision of a paging message transmission mechanism applicable to the enhanced coverage MTC user equipment and/or the low complexity or low cost MTC user equipment.

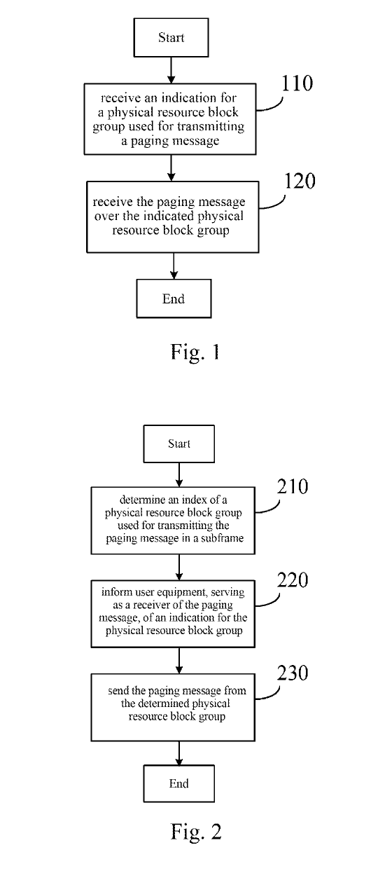

FIG. 1 shows a method for receiving a paging message according to an embodiment of the present invention. As illustrated in FIG. 1, at step 110, user equipment receives an indication for a physical resource block group used for transmitting the paging message. An index of the physical resource block group in a subframe is determined according to a level of the paging message. At step 120, the user equipment receives the paging message from the indicated physical resource block group.

In some embodiments of the present invention, the level of the paging message is obtained by one of: being configured by a base station via the broadcast system information and/or UE dedicated Radio Resource Control signaling; being configured by a network side via NAS signaling; and being determined by the user equipment according to a measurement result of the user equipment.

In some embodiments of the present invention, the index of the physical resource block group in a subframe refers to an index of a starting resource block of the physical resource block group in the subframe.

In some embodiments of the present invention, sizes of the physical resource block groups are the same for paging messages at different levels.

In some embodiments of the present invention, the size of the physical resource block group is determined according to the level of the paging message.

In some embodiments of the present invention, the level of the paging message is also used for determining the number of repetitions of one or more physical downlink shared channels, physical uplink shared channels, physical downlink control channels and/or enhanced physical downlink control channels, physical uplink control channels, and physical random access channels.

In some embodiments of the present invention, the level of the paging message is also used for determining a transmission time interval bundle size of one or more physical downlink shared channels, physical uplink shared channels, physical downlink control channels and/or enhanced physical downlink control channels, physical uplink control channels, and physical random access channels.

In some embodiments of the present invention, the receiving the indication for the physical resource block group used for transmitting the paging message comprises: receiving the index of the physical resource block group in a subframe and/or the size of the physical resource block group from a base station via broadcast system information and/or UE dedicated Radio Resource Control signaling; or receiving the index of the physical resource block group in a subframe and/or the size of the physical resource block group from network side equipment via non-access stratum (NAS) signaling.

In some embodiments of the present invention, a system bandwidth used by the user equipment includes 6 physical resource blocks. In such a condition, the physical resource block group is a subgroup of the system bandwidth.

However, there may be a case in which the system bandwidth includes more than 6 physical resource blocks. In some embodiments of the present invention, in the case that the system bandwidth includes more than 6 physical resource blocks, the system bandwidth may include a plurality of sub-bands. Each of the plurality of the sub-bands contains no more than 6 physical resource blocks. For example, in the case that the number of physical resource blocks included in the system bandwidth is evenly divisible by 6, each of the plurality of the sub-bands contains 6 physical resource blocks. However, in the case that the number of physical resource blocks included in the system bandwidth is not evenly divisible by 6, the number of physical resource blocks included in one of the plurality of the sub-bands may be less than 6 while the rest of the sub-bands may each include 6 physical resource blocks. There may be other sub-band allocation manners; for example, the number of physical resource blocks in other communication systems may be any number other than 6. The starting index and the size of the resource block group for the paging message in the sub-band can be determined by the aforementioned solutions as long as the number of physical resource blocks corresponding to the paging message is less than the total number of resource blocks included in the sub-band. The present invention is not limited to the number of specific resource blocks included in the system bandwidth/sub-band.

In either case, the paging message is received on one of the plurality of the sub-bands which is determined by a network node (e.g., a base station or a network side).

FIG. 2 shows a method for sending a paging message at a network node side according to an embodiment of the present invention. In the flow chart illustrated in FIG. 2, the method includes the following steps: 210 to 230. In step 210, an index of a physical resource block group used for transmitting the paging message in a subframe is determined according to a level of the paging message. In step 220, user equipment, which serves as a receiver of the paging message, is being informed of an indication for the physical resource block group. In step 230, the paging message is sent from the determined physical resource block group.

In some embodiments of the present invention, the level of the paging message is obtained by one of: being prestored by a network node; being informed by an upper network node (for example, if the network node is a base station, being indicated by the network side through an S1 paging message); and being determined by user equipment according to a measurement result of the user equipment and the network node being notified.

In some embodiments of the present invention, the index of the physical resource block group in a subframe refers to an index of a starting resource block of the physical resource block group in a subframe.

In some embodiments of the present invention, sizes of the physical resource block groups are the same for paging messages at different levels.

In some embodiments of the present invention, the size of the physical resource block group is determined according to the level of the paging message.

In some embodiments of the present invention, the level of the paging message is also used for determining the number of repetitions of one or more physical downlink shared channels, physical uplink shared channels, physical downlink control channels and/or enhanced physical downlink control channels, physical uplink control channels, and physical random access channels.

In some embodiments of the present invention, the level of the paging message is also used for determining a transmission time interval bundle size of one or more physical downlink shared channels, physical uplink shared channels, physical downlink control channels and/or enhanced physical downlink control channels, physical uplink control channels, and physical random access channels.

In some embodiments of the present invention, the informing the user equipment, which serves as a receiver of the paging message, of the indication for the physical resource block group includes: if the network node is a base station, sending the index of the physical resource block group in a subframe and/or the size of the physical resource block group to the user equipment via broadcast system information and/or UE dedicated Radio Resource Control signaling; or if the network node is network side equipment, sending the index of the physical resource block group in a subframe and/or the size of the physical resource block group to the user equipment via non-access stratum (NAS) signaling. However, the present invention is not limited thereto. For example, the base station may also send the index of the physical resource block group in a subframe using other group-sending mechanisms (e.g., a multicast mechanism, etc.).

In some embodiments of the present invention, a system bandwidth allocated for the user equipment by the network node includes 6 physical resource blocks. In such a condition, the physical resource block group is a subgroup of the system bandwidth.

In some embodiments of the present invention, in the case that the system bandwidth allocated for the user equipment by the network node includes more than 6 physical resource blocks, the system bandwidth is divided into a plurality of sub-bands, with each containing no more than 6 physical resource blocks, and one of the plurality of the sub-bands where the paging message is sent to the user equipment is determined.

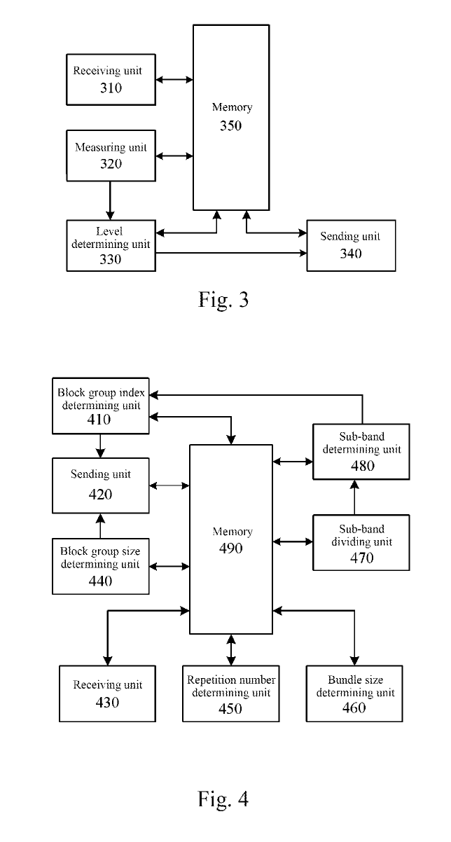

FIG. 3 shows user equipment for sending a paging message according to an embodiment of the present invention. The user equipment includes at least a receiving unit 310, configured to receive an indication for a physical resource block group used for transmitting the paging message and to receive the paging message from the indicated physical resource block group. An index of the physical resource block group in a subframe is determined according to a level of the paging message.

In some embodiments of the present invention, the level of the paging message is configured by a base station via broadcast system information and/or UE dedicated Radio Resource Control signaling or is configured by a network side via NAS signaling, and is received by the receiving unit 310. In some embodiments of the present invention, the user equipment further includes a measuring unit 320, configured to measure a channel state, and a level determining unit 330, configured to determine the level of the paging message according to a measurement result of the measuring unit.

In some embodiments of the present invention, the index of the physical resource block group in a subframe refers to an index of a starting resource block of the physical resource block group in the subframe.

In some embodiments of the present invention, sizes of the physical resource block groups are the same for paging messages at different levels.

In some embodiments of the present invention, the size of the physical resource block group is determined by a network node (which may be, based on different implements, a base station or network side equipment, such as a mobility management entity (MME)) according to the level of the paging message, and is received by the receiving unit 310 via the broadcast system information and/or UE dedicated Radio Resource Control signaling.

The indication for the physical resource block group may include the index of the physical resource block group in a subframe and the size of the physical resource block group. In some embodiments of the present invention, the receiving unit 310 is further configured to receive the index of the physical resource block group in a subframe and/or the size of the physical resource block group from a base station via broadcast system information and/or UE dedicated Radio Resource Control (UE dedicated RRC) signaling. Alternatively, in some embodiments of the present invention, the receiving unit 310 is further configured to receive the index of the physical resource block group in a subframe and/or the size of the physical resource block group from network side equipment via non-access stratum signaling.

In some embodiments of the present invention, a system bandwidth used by the user equipment includes 6 physical resource blocks. The physical resource block group is a subgroup of the system bandwidth.

In some embodiments of the present invention, in the case that the system bandwidth used by the user equipment includes more than 6 physical resource blocks, the system bandwidth includes a plurality of sub-bands, and each of the plurality of the sub-bands contains no more than 6 physical resource blocks. In either case, the paging message is received by the receiving unit 310 on one of the plurality of the sub-bands determined by a network node (e.g., a base station or a network side).

In some embodiments of the present invention, the user equipment further includes a memory 340, configured to store various types of information received by the receiving unit 310, such as the paging message, the size of the physical resource block group, the index of the physical resource block group in a subframe, and information received by other user equipment. The memory 350 can also store information used or outputted by the measuring unit 320 and the level determining unit 330, such as the measurement results of the measuring unit 320. In such a case, the level determining unit 330 can obtain the measurement results from the memory 350. The memory 350 can also store information to be sent by the sending unit 340, such as the level of the paging message determined by the level determining unit 330.

FIG. 4 shows a network node for sending a paging message according to an embodiment of the present invention. The network node, as illustrated in FIG. 4, includes at least: a block group index determining unit 410, configured to determine an index of a physical resource block group used for transmitting the paging message in a subframe according to a level of the paging message; and a sending unit 420, configured to inform user equipment, which serves as a receiver of the paging message, of an indication for the physical resource block group determined by the block group index determining unit 410, and to send the paging message from the determined physical resource block group.

In some embodiments of the present invention, the network node further includes a receiving unit 430. The level of the paging message is prestored by the network node, or being informed by an upper network node, or is determined by user equipment according to a measurement result of the user equipment and the network node being notified, and is received by the receiving unit 430.

In some embodiments of the present invention, the index of the physical resource block group in a subframe refers to an index of a starting resource block of the physical resource block group in the subframe.

In some embodiments of the present invention, sizes of the physical resource block groups are the same for paging messages at different levels.

In some embodiments of the present invention, the network node further includes: a block group size determining unit 440, configured to determine the size of the physical resource block group according to the level of the paging message.

In some embodiments of the present invention, the network node further includes: a repetition number determining unit 450, configured to determine, according to the level of the paging message, the number of repetitions of one or more physical downlink shared channels, physical uplink shared channels, physical downlink control channels and/or enhanced physical downlink control channels, physical uplink control channels and physical random access channels.

In some embodiments of the present invention, the network node further includes: a bundle size determining unit 460, configured to determine, according to the level of the paging message, a transmission time interval bundle size of one or more physical downlink shared channels, physical uplink shared channels, physical downlink control channels and/or enhanced physical downlink control channels, physical uplink control channels and physical random access channels.

In some embodiments of the present invention, if the network node is a base station, the sending unit 420 sends the index of the physical resource block group in a subframe and/or the size of the physical resource block group to the user equipment via broadcast system information and/or UE dedicated Radio Resource Control (UE dedicated RRC) signaling. Alternatively, if the network node is network side equipment, the sending unit 420 sends the index of the physical resource block group in a subframe and/or the size of the physical resource block group to the user equipment via non-access stratum signaling.

In some embodiments of the present invention, a system bandwidth allocated for the user equipment by the network node includes 6 physical resource blocks. In such a condition, the physical resource block group is a subgroup of the system bandwidth.

In some embodiments of the present invention, the network node further includes: a sub-band dividing unit 470, configured to, in the case that a system bandwidth allocated for the user equipment by the network node includes more than 6 physical resource blocks, devide the system bandwidth into a plurality of sub-bands, with each containing no more than 6 physical resource blocks; and a sub-band determining unit 480, configured to determine, from the plurality of the sub-bands divided by the sub-band dividing unit 470, one sub-band where the paging message is sent to the user equipment.

In some embodiments of the present invention, the network node further includes a memory 490. The memory 490 can store information to be sent by the sending unit 420 such as the paging message, and information received by the receiving unit 430, such as the level of the paging message received by the receiving unit 430 from the network side (e.g., MME) or the user equipment. The memory 490 can also store information required or outputted by units such as the block group index determining unit 410, the block group size determining unit 440, the repetition number determining unit 450, the bundle size determining unit 460, the sub-band dividing unit 470, and the sub-band determining unit 480.

The above network node according to the present invention may be a base station or network side equipment, such as the mobility management entity (MME) of the network side. Certainly, the above network node according to the present invention may be any network side equipment generally used by a person skilled in the art to configure transmission/mobility parameters. Examples of the network node is therefore not limited in the present invention.

It should be noted that the user equipment and the network node illustrated in FIG. 3 and FIG. 4 are provided only for a person skilled in the art to have a better understanding of the present invention. Some modules/components, not required for the understanding of the present invention, are omitted in FIG. 3 and FIG. 4. The scope of the present invention should not be limited by the details of these accompanying drawings. In addition, actual equipment may include more modules/components, such as a display, an operation maintenance interface (e.g., for the network node in FIG. 4), an I/O interface, etc. The present invention does not impose any limitation on the choice of equipment.

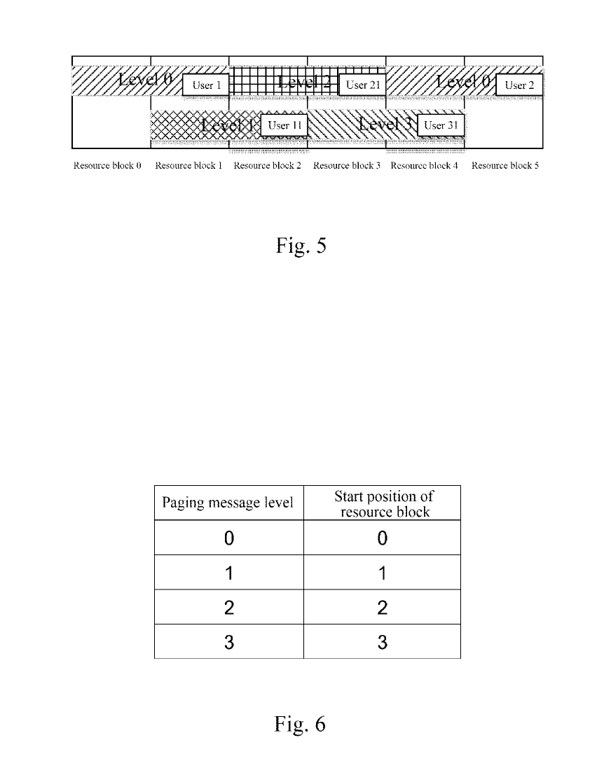

In the following, the methods as illustrated in FIG. 1 and FIG. 2 and the equipment as illustrated in FIG. 3 and FIG. 4 will be described in detail with reference to FIG. 5-FIG. 10. It should be noted that the determining and sending of most of the information in the present invention may be performed by a base station or by network side equipment. Therefore, unless otherwise specified, terms ‘base station’, ‘network side equipment’ (e.g., MME) and ‘network node’ in the description can be used interchangeably. In addition, as described above, although the present invention is mainly described with respect to MTC user equipment requiring additional coverage enhancement or low complexity/low cost MTC user equipment, the present invention is likewise applicable to other user equipment supporting delay tolerance service and/or requiring a certain coverage enhancement.

For enhanced coverage MTC UE, its uplink and downlink physical channels require repeated transmissions to meet the requirement for channel coverage enhancement. UE located in different geographic positions require different channel coverage enhancement degrees, resulting in different numbers of repeated transmissions required by physical channels of UE in different geographic positions. Therefore, the coverage enhancement degrees of physical channels can be divided into several coverage enhancement levels. Physical channels of different coverage enhancement levels require different numbers of repeated transmissions. For example, physical channels can be divided into four coverage enhance levels (CE0, CE1, CE2, and CE3). The physical channel corresponding to each coverage enhancement level requires a different coverage enhancement compensation. For example, CE0 refers to coverage enhancement level 0, i.e., no coverage enhancement is required; CE1 refers to coverage enhancement level 1, i.e., for example, a coverage enhancement of 1-5 dB is required, and the physical channel of this coverage enhance level generally requires several repeated transmissions; CE2 refers to coverage enhancement level 2, i.e., for example, a coverage enhancement of 6-10 dB is required, and the physical channel of this coverage enhance level generally requires a dozen of repeated transmissions; and CE3 refers to coverage enhancement level 3, i.e., for example, a coverage enhancement of 11-15 dB is required, and the physical channel of this coverage enhance level generally requires tens of repeated transmissions. It should be noted, however, that the technical solution of the present invention is not limited to four coverage enhancement levels, but can adopt more or less coverage enhancement levels as required. It should also be noted that the numbers of repetitions of the physical channels as stated above are only set forth as examples to make a person skilled in the art to clearly understand the present invention, and the number of repetitions in a specific system will not be limited to the above numbers and could be more or less according to the requirement/limitation of the system (e.g., system resource limitation).

Since the control channel corresponding to paging messages is not available for transmission, it is required to provide the position of the paging message of MTC user equipment in the frequency domain. In the technical solution of the present invention, the network node (e.g., the base station) maps paging messages at different levels to different resource block groups (RB group) to indicate positions of the paging messages in the frequency domain. The resource block group used herein refers to a group of physical resource blocks occupied by a paging message on a subframe. The size of a resource block group refers to the number of resource blocks occupied by a paging message on a subframe. The resource block group used herein may be a physical resource block group (PRB group) or a virtual resource block group (VRB group). The mapping relationship between physical resource blocks and virtual resource blocks can be referred to 3GPP TS36.211 6.2.3.1 and will not be repeated in the present invention. In the technical solution of the present invention, multiple resource blocks can be virtually and consecutively allocated, i.e., virtual resource blocks of localized type. The virtual resource blocks of localized type here refer to directly mapping the virtual resource block n_{RB} to the physical resource block n_{PRB}. The size of the virtual resource block is the same as the size of the physical resource block.

A paging message may occupy multiple subframes, and paging messages at different levels may occupy different numbers of subframes. Different user equipment may occupy different subframes. For example, the user equipment can receive paging messages from different subframes according to the user ID, or can perform subframe allocation by a time domain multiplexing method for paging messages in 3GPP protocol. In some embodiments of the present invention, it is necessary to determine two parameters: a start position of a physical resource block group carrying a paging message and the number of consecutively allocated resource blocks.

However, in other embodiments, since the size of the physical resource block group carrying the paging message (i.e., the number of consecutively allocated resource blocks) is predetermined and is the same for paging messages at different levels, only the start position of the physical resource block group needs to be determined

Referring to FIG. 2 again, at step 210 in FIG. 2, the index of the physical resource block group used for transmitting the paging message in a subframe is determined according to the level of the paging message. The step is performed by the block group index determining unit 410 illustrated in FIG. 4. According to the present invention, the start position of the physical resource block group and the index of the physical resource block group in a subframe express the same concept and can be used interchangeably. Based on cases whether the sizes of resource block groups carrying paging messages at different levels are the same, two solutions are provided in the present invention. The network node and the user equipment can support the two cases or one of the two cases.

FIG. 5 shows a case in which the sizes of resource block groups carrying paging messages at different levels are the same. As shown in FIG. 5, the system bandwidth is of a size of 6 physical resource blocks, and the sizes of the resource block groups carrying paging messages at different levels are the same. The start positions of respective resource block groups are allocated by the base station and/or the network side (e.g., MME) according to a principle that physical resource blocks in subframes are fully utilized or other principles which can be conceived or generally used by a person skilled in the art. In the example shown in FIG. 5, the relationship between the start positions of resource block groups and paging messages at different levels may be: the index of the start position of the resource block group corresponding to a paging message at coverage enhancement level 0 is 0 or 4; the index of the start position of the resource block group corresponding to a paging message at coverage enhancement level 1 is 1; the index of the start position of the resource block group corresponding to a paging message at coverage enhancement level 2 is 2; and the index of the start position of the resource block group corresponding to a paging message at coverage enhancement level 3 is 3. In the example as shown in FIG. 5, correspondingly, the resource block group carrying a paging message is of the size of, for example, 2 resource blocks. However, the number may be more or less in other examples and index allocation manners different from that shown in FIG. 5 may be adopted.

The level of the paging message may be configured ed for the user equipment by a base station via broadcast information and/or UE dedicated RRC signaling or by a network side (e.g., MME) via NAS signaling. In some embodiments, the level of the paging message may be determined by the user equipment according to the downlink measurement result of the user equipment. For example, the user equipment performs channel measurement with the measuring unit 320 and compares the measured reference signal received power (RSRP) of the downlink channel with a specific threshold with the level determining unit 330. The specific threshold may be a threshold specified in 3GPP technical specification TS36.104, which can be received in advance by the user equipment with the receiving unit 310 from a base station/network side and stored in the memory 350 of the user equipment. If the measured RSRP is greater than or equal to the threshold, the level determining unit 330 determines the level of the paging message to be 0; if the measured RSRP is 1-5 dB, being less than the threshold, the level of the paging message is determined to be 1; if the measured RSRP is 6-10 dB, being less than the threshold, the level of the paging message is determined to be 2; and if the measured RSRP is 11-15 dB, being less than the threshold, the level of the paging message is determined to be 3.

Optionally, after the level of the paging message is determined, the user equipment/base station/network side can store the level of the paging message for next determination of the start position of the resource block group or for other purposes.

After the block group index determining unit 410 determines the index of the physical resource block group used for transmitting the paging message in a subframe, at step 220, the network node informs the user equipment, which serves as a receiver of the paging message, of an indication for the physical resource block group. In some embodiments, the indication for the physical resource block group may include the index of the physical resource block group in a subframe and may optionally include the size of the physical resource block group. The index of the physical resource block group in a subframe is determined by the block group index determining unit 410. However, in other embodiments, the user equipment is being informed of the size of the physical resource block group in advance.

The number of resource blocks carrying paging messages at different levels may be predetermined and configured for user equipment by, for example, the base station via broadcast information and/or UE dedicated RRC signaling. In other embodiments, the number of resource blocks carrying paging messages at different levels may be configured ed by the network side (e.g., MME) via NAS signaling. In addition, the index of the physical resource block group in a subframe may be informed by the base station via broadcast system information and/or UE dedicated RRC signaling, or by the network side (e.g., MME) via NAS signaling. According to the present invention, the index of the resource block group carrying the paging message in a subframe and indexes of starting resource blocks in these resource blocks express the same meaning and can be used interchangeably.

In some examples, the level of the paging message may be used by the repetition number determining unit 450 of the base station for determining the number of repetitions of one or more physical downlink shared channels, physical uplink shared channels, physical downlink control channels, physical uplink control channels, and physical random access channels.

In some examples, the level of the paging message may be used by the bundle size determining unit 460 of the base station for determining the size of the transmission time interval bundle (TTI bundle) of one or more physical downlink shared channels, physical uplink shared channels, physical downlink control channels, physical uplink control channels, and physical random access channels.

FIG. 6 is another schematic diagram of a correspondence between paging messages at different levels and the starting indexes of corresponding resource blocks. However, this figure is only an example for describing the present invention and the present invention should not be limited by it. For example, the level of the paging message can also correspond to two start positions of resource blocks, such as indexes 0 and 4, and is not limited to index 0.

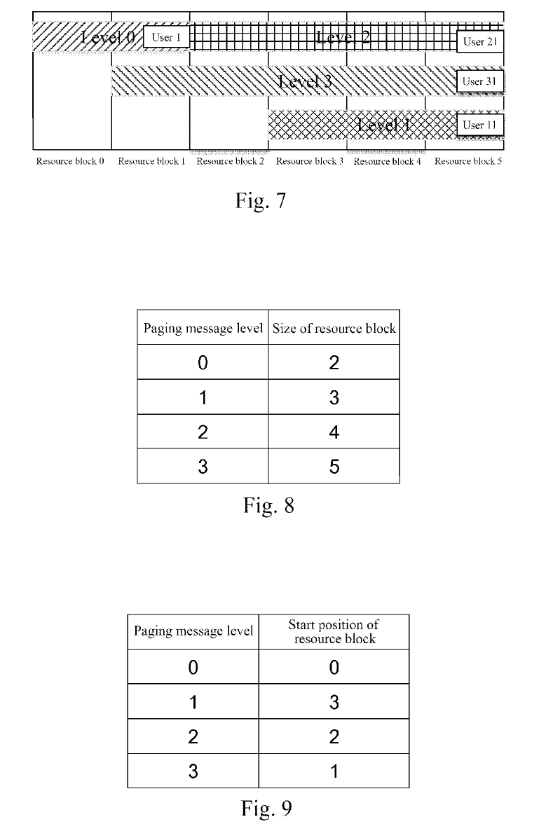

FIG. 7 shows a case in which the sizes of resource block groups carrying paging messages at different levels are different. As shown in FIG. 7, the system bandwidth is of a size of 6 physical resource blocks, and the sizes of the resource block groups carrying paging messages at different levels are different. The start positions of respective resource block groups are configured ed by the base station and/or the network side (e.g., MME) according to the principle that physical resource blocks in subframes are fully utilized or other principles which can be conceived or generally used by a person skilled in the art. In the example shown in FIG. 7, the relationship between the start positions of resource block groups and paging messages at different levels may be: the index of the start position of the resource block group corresponding to a paging message at coverage enhancement level 0 is 0; the index of the start position of the resource block group corresponding to a paging message at coverage enhancement level 1 is 3; the index of the start position of the resource block group corresponding to a paging message at coverage enhancement level 2 is 2; and the index of the start position of the resource block group corresponding to a paging message at coverage enhancement level 3 is 1.

In the example shown in FIG. 7, since the sizes of resource block groups carrying paging messages at different levels are different, the sizes of the resource block groups need to be determined This operation can be performed by the block group size determining unit 440 illustrated in FIG. 4. In some examples, the number of resource blocks carrying paging messages at different levels may be: the number of resource blocks corresponding to a paging message at coverage enhancement level 0 is 2; the number of resource blocks corresponding to a paging message at coverage enhancement level 1 is 3; the number of resource blocks corresponding to a paging message at coverage enhancement level 2 is 4; and the number of resource blocks corresponding to a paging message at coverage enhancement level 3 is 5. Certainly, a person skilled in the art can also select different resource block group size allocation solutions according to the actual demand (e.g., system resource limitation) as long as a paging message at a higher coverage enhancement level corresponds to a greater number of resource blocks theoretically.

Other technical features of the case illustrated in FIG. 7 are the same as these of the case illustrated in FIG. 5 and will not be repeated herein.

FIG. 8 shows a mapping relationship between levels of paging messages and the sizes of resource block groups in the case that the sizes of resource block groups carrying paging messages at different levels are different. FIG. 9 shows a mapping relationship between levels of paging messages and the start positions of resource blocks in the case that the sizes of resource block groups carrying paging messages at different levels are different. As described above, these mapping relationships are only set forth as an example for describing the present invention and the present invention should not be limited by it.

After the block group index determining unit 410 determines the index of a physical resource block group used for transmitting the paging message in a subframe, and the block group size determining unit 410 determines the size of the physical resource block group, at step 220, the network node informs user equipment, which serves as a receiver of the paging message, of an indication for the physical resource block group. In some embodiments, the indication for the physical resource block group may include the index of the physical resource block group in a subframe and the size of the physical resource block group. The index of the physical resource block group in a subframe is determined by the block group index determining unit 410, and the size of the physical resource block group is determined by the block group size determining unit 440.

At step 230, the sending unit 420 of the network unit sends the paging message from the determined physical resource block group.

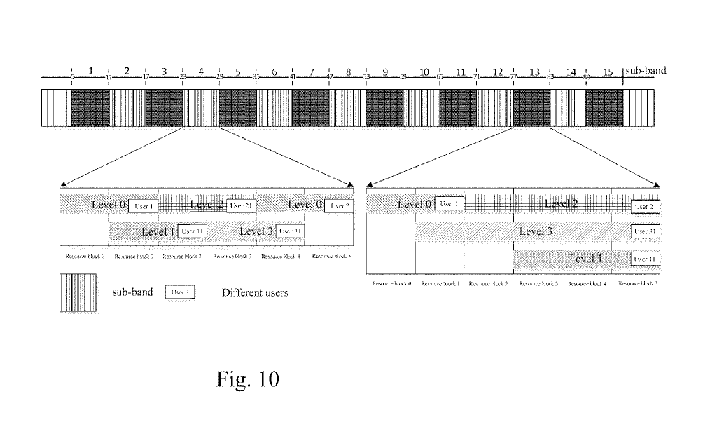

However, there may be a case in which the system bandwidth includes more than 6 physical resource blocks in 3GPP LTE. FIG. 10 illustrates the processing in such a case according to the present invention. As illustrated in FIG. 10, in the case that the system bandwidth includes more than 6 physical resource blocks, the system bandwidth may be divided into a plurality of sub-bands. The technical solution shown in FIG. 1-FIG. 9 can still be performed in each sub-band. In the case shown in FIG. 10, the network node also needs to inform the user equipment of the division of sub-bands with the sending unit 430. Each sub-band may include 6 consecutive physical resource blocks. Likewise, the division of sub-bands can be configured to the user equipment by the base station via broadcast system information and/or UE dedicated RRC signaling or by the network side (e.g., MME) via NAS signaling.

As a general example, it is assumed that the system bandwidth includes M PRBs and may be divided into N sub-bands, wherein M and N are required to meet the formula N=floor (M, 6), i.e., N is the maximum natural number less than the quotient obtained by dividing M with 6. Therefore, the entire system bandwidth can be divided into N sub-bands, with each having a bandwidth of 6 physical resource blocks and a sub-band having a bandwidth of (M-6*N) physical resource blocks. From the above formula, it can be seen that, in the case that M is not an integer multiple of 6, there may exists a sub-band including fewer than 6 physical resource blocks. In such a case, the starting index and size of the resource block group for the paging message in the sub-band can be determined by the above-described solution as long as the number of physical resource blocks corresponding to the paging message is less than the total number of resource blocks included in the sub-band. The present invention is not limited to the number of specific resource blocks contained in the system bandwidth/sub-band.

The user equipment needs to receive the paging message from one sub-band which is determined before being configured/determining the index of the physical resource block group in a subframe and/or the size of the physical resource block. In some embodiments of the present invention, the sub-band used by the user equipment is determined according to the level of the paging message. For example, the sub-band used by the user equipment can be determined by the following equation: [index of sub-band]=[UE ID] mod [the number of sub-band], wherein UE ID may be an international mobile subscriber identity (IMSI) for uniquely identifying a user in the core network. The identity is stored in a SIM card. Certainly, in other embodiments of the present invention, a person skilled in the art can also use other possible identities uniquely identifying users and make adaptive modifications to the above equation, which is not limited in the present invention.

At the user equipment side, the receiving unit 310 of the user equipment receives, at step 110, the indication for the physical resource block group used for transmitting the paging message. The indication may include the index of the physical resource block group used for transmitting the paging message in a subframe. In some cases, the indication may also include the size of the physical resource block group. However, in other cases, the size of the physical resource block group is determined by the network node and sent to the user equipment in advance (e.g., in the case that the size of the physical resource block group is fixed with respect to paging messages at different levels).

However, at step 120, the user equipment can receive the paging message from the indicated physical resource block group with the receiving unit 310.

When the user equipment is in an RRC CONNECT state, the base station and/or the network side (e.g., MME) has configured the user equipment to operate on one sub-band to receive data. At this moment, when the user equipment needs to be paged, the paging message can be transmitted from the current sub-band, and the physical resource block group used for transmitting the paging message can be determined using the method illustrated in FIG. 1-FIG. 9.

It should be understood that the above embodiments of the present invention may be implemented through software, hardware or a combination of software and hardware. For example, various components in the base station and the user equipment in the above embodiments may be implemented through various devices, including but not limited to an analog circuit device, a digital circuit device, a digital signal processing (DSP) circuit, a programmable processor, an application specific integrated circuit (ASIC), a field programmable gate array (FPGA), a programmable logic devices (CPLD), and the like.

In this application, the ‘base station’ refers to a mobile communication data and control switching center with large transmission power and wide coverage area, including resource allocation scheduling, data receiving, and transmitting functions. The term ‘user equipment’ refers to a user mobile terminal, such as a terminal device that can perform wireless communication with a base station or a micro base station, including a mobile phone, a notebook, or the like.

In addition, the embodiments of the present invention, disclosed herein, may be implemented on a computer program product. More specifically, the computer program product is a product described as below. The product has a computer-readable medium on which a computer program logic is encoded. The computer program logic provides relevant operations to implement the above-described technical solution of the present invention when the product is executed on a computing device. The computer program logic enables a processor to execute the operations (methods) described in the embodiments of the present invention when the product is executed on at least one processor of a computing system. Such an arrangement of the present invention is typically provided as software, a code, and/or other data structures that are configured or encoded on a computer-readable medium, such as a light medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device perform the technical solutions described in the embodiments of the present invention.

Although the present invention has been shown in connection with the preferred embodiments of the present invention, it will be understood by those skilled in the art that various modifications, substitutions, and alterations may be made therein without departing from the spirit and scope of the present invention. Accordingly, the present invention should not be defined by the above-described embodiments, but should be defined by the appended claims and their equivalents.

1. A method for user equipment to receive a paging message, comprising:
receiving an indication for a physical resource block group used for transmitting the paging message, wherein an index of the physical resource block group in a subframe is determined according to a level of the paging message; and
receiving the paging message from the indicated physical resource block group.

2-7. (canceled)

8. The method according to claim 1, wherein the receiving an indication for a physical resource block group used for transmitting the paging message comprises:
receiving an index of the physical resource block group in a subframe and/or a size of the physical resource block group from a base station via broadcast system information and/or user equipment dedicated Radio Resource Control signaling; or
receiving the index of the physical resource block group in a subframe and/or the size of the physical resource block group from network side equipment via non-access stratum signaling.

9-10. (canceled)

11. A method for a network node to send a paging message, comprising:
determining an index of a physical resource block group used for transmitting the paging message in a subframe according to a level of the paging message;
informing user equipment, serving as a receiver of the paging message, of an indication for the physical resource block group; and
sending the paging message from a determined physical resource block group.

12. The method according to claim 11, wherein a level of the paging message is obtained by one of:
being prestored by the network node;
being informed by an upper network node; or
being determined by user equipment according to a measurement result of the user equipment and the network node being notified.

13. The method according to claim 11, wherein the index of the physical resource block group in a subframe refers to an index of a starting resource block of the physical resource block group in the subframe.

14-17. (canceled)

18. The method according to claim 11, wherein the informing the user equipment, serving as a receiver of the paging message, of the indication for the physical resource block group comprises:
if the network node is a base station, sending the index of the physical resource block group in a subframe and/or a size of the physical resource block group to the user equipment via broadcast system information and/or user equipment dedicated Radio Resource Control signaling; or
if the network node is network side equipment, sending the index of the physical resource block group in a subframe and/or the size of the physical resource block group to the user equipment via non-access stratum signaling.

19-20. (canceled)

21. User equipment, comprising:
a receiving unit, configured to receive an indication for a physical resource block group used for transmitting a paging message, and receive the paging message from the indicated physical resource block group, wherein an index of the physical resource block group in a subframe is determined according to a level of the paging message.

22. (canceled)

23. The user equipment according to claim 21, wherein the index of the physical resource block group in a subframe refers to an index of a starting resource block of the physical resource block group in the subframe.

24-25. (canceled)

26. The user equipment according to claim 21, wherein the indication for the physical resource block group comprises an index of the physical resource block group in a subframe and a size of the physical resource block group; and
the receiving unit is further configured to receive the index of the physical resource block group in a subframe and/or the size of the physical resource block group from the base station via broadcast system information and/or user equipment dedicated Radio Resource Control signaling; or
the receiving unit is further configured to receive the index of the physical resource block group in a subframe and/or the size of the physical resource block group from network side equipment via non-access stratum signaling.

27. The user equipment according to claim 21, wherein a system bandwidth used by the user equipment comprises 6 physical resource blocks, and the physical resource block group is a subgroup of the system bandwidth.

28. The user equipment according to claim 21, wherein in the case that a system bandwidth used by the user equipment comprises more than 6 physical resource blocks, the system bandwidth comprises a plurality of sub-bands, wherein each of the plurality of sub-bands contains no more than 6 physical resource blocks, and the paging message is received by the receiving unit 310 on one of the plurality of the sub-bands determined by the network node.

29. A network node, comprising:
a block group index determining unit, configured to determine an index of a physical resource block group used for transmitting a paging message in a subframe according to a level of the paging message; and
a sending unit, configured to inform user equipment, serving as a receiver of the paging message, of an indication for the physical resource block group determined by the block group index determining unit, and to send the paging message from the determined physical resource block group.

30. The network node according to claim 29, further comprising a receiving unit, wherein
a level of the paging message is prestored by the network node, or is being notified by an upper network node, or is determined by the user equipment according to a measurement result of the user equipment and the network node being notified, and is received by the receiving unit.

31. The network node according to claim 29, wherein the index of the physical resource block group in a subframe refers to an index of a starting resource block of the physical resource block group in the subframe.

32-33. (canceled)

34. The network node according to claim 29, further comprising: a repetition number determining unit, configured to determine, according to the level of the paging message, the number of repetitions of one or more physical downlink shared channels, physical uplink shared channels, physical downlink control channels and/or enhanced physical downlink control channels, physical uplink control channels, and physical random access channels.

35. The network node according to claim 29, further comprising: a bundle size determining unit, configured to determine, according to the level of the paging message, a transmission time interval bundle size of one or more physical downlink shared channels, physical uplink shared channels, physical downlink control channels and/or enhanced physical downlink control channels, physical uplink control channels, and physical random access channels.

36. The network node according to claim 29, wherein the indication for the physical resource block group comprises an index of the physical resource block group in a subframe and a size of the physical resource block group; and
if the network node is a base station, the sending unit sends the index of the physical resource block group in a subframe and/or the size of the physical resource block group to the user equipment via broadcast system information and/or user equipment dedicated Radio Resource Control signaling; or
if the network node is network side equipment, the sending unit sends the index of the physical resource block group in a subframe and/or the size of the physical resource block group to the user equipment via non-access stratum signaling.

37. The network node according to claim 29, wherein a system bandwidth allocated for the user equipment by the network node comprises 6 physical resource blocks, and the physical resource block group is a subgroup of the system bandwidth.

38. The network node according to claim 29, further comprising:
a sub-band dividing unit, configured to, in the case that a system bandwidth allocated for the user equipment by the network node comprises more than 6 physical resource blocks, divide the system bandwidth into a plurality of sub-bands, wherein each of the plurality of the sub-bands contains no more than 6 physical resource blocks; and
a sub-band determining unit, configured to determine, from the plurality of the sub-bands divided by the sub-band dividing unit, one sub-band where the paging message is sent to the user equipment.
